(19) United States
(12) Patent Application Publication
(10) Pub. No.: US 2025/0373889 A1
(43) Pub. Date: Dec. 4, 2025

(54) DISPLAY APPARATUS AND CONTROLLING METHOD THEREOF

(71) Applicant: SAMSUNG ELECTRONICS CO., LTD., Suwon-si (KR)

(72) Inventors: Changwon Lee, Suwon-si (KR); Jungkeun Kim, Suwon-si (KR)

(73) Assignee: SAMSUNG ELECTRONICS CO., LTD., Suwon-si (KR)

(21) Appl. No.: 19/305,368

(22) Filed: Aug. 20, 2025

Related U.S. Application Data
(63) Continuation of application No. PCT/KR2023/021226, filed on Dec. 21, 2023.

(30) Foreign Application Priority Data
Feb. 21, 2023 (KR) 10-2023-0022959

(51) Int. Cl. H04N 21/4363; G06F 3/14; H04N 21/4402

(52) U.S. Cl. CPC H04N 21/43635; G06F 3/14; H04N 21/440281

(57) ABSTRACT

A display apparatus according to an embodiment may include: a display, a second standard port connected to a first standard port of an external device; communication circuitry configured to receive a first standard image and variable refresh rate information through the second standard port; a controller configured to convert the first standard image into a second standard image based on the variable refresh rate information, and control the display to display the converted second standard image.

### CROSS-REFERENCE TO RELATED APPLICATIONS

This application is a continuation of International Application No. PCT/KR2023/021226, filed on Dec. 21, 2023, which is based on and claims priority to Korean Patent Application No. 10-2023-0022959, filed on Feb. 21, 2023, in the Korean Intellectual Property Office, the disclosures of which are incorporated by reference herein in their entireties.

### BACKGROUND

### 1. Field

The disclosure relates to a display apparatus and a method of controlling the same, configured to receive an image transmitted via a DisplayPort (DP) interface through a High-Definition Multimedia Interface (HDMI) interface and to reproduce the image.

### 2. Description of Related Art

An electronic device (e.g., a source device), such as a computer or smartphone, may be connected to a display apparatus (e.g., a sink device), such as a television, to output content through the sink device. Data transmission and reception between the source device and the sink device are performed based on standards that are supported by both devices. For example, standards defining communication methods between devices include interface standards such as DisplayPort (DP) (registered trademark) and High Definition Multimedia Interface (HDMI) (registered trademark).

The DisplayPort interface, established by the Video Electronics Standards Association (VESA), is an interface that enables digital connectivity not only for internal connections between chips but also external connections between products.

Recently, research has been conducted on technologies for transmitting an image from a source device equipped with a DisplayPort interface to a sink device equipped with a HDMI port interface. However, due to differences in the specifications, there have been limitations in providing a variable refresh rate (VRR) function.

### SUMMARY

Provided are a display apparatus and a method of controlling the same that are capable of detecting a variable refresh rate (VRR) activation signal received from a source device equipped with a DisplayPort (DP) interface to provide a VRR function on a sink device equipped with an HDMI interface, thereby actively adjusting the refresh rate of the display apparatus and thus minimizing tearing and input delay.

Additional aspects will be set forth in part in the description which follows and, in part, will be apparent from the description, or may be learned by practice of the presented embodiments.

According to an embodiment, a display apparatus may be provided. The display apparatus may include: a display; a second standard port connected to a first standard port of an external device; communication circuitry configured to receive a first standard image and variable refresh rate information through the second standard port; a controller including at least one processor, wherein the controller is configured to convert the first standard image to a second standard image based on the variable refresh rate information, and control the display to display the converted second standard image.

The controller may convert the first standard image to the second standard image based on a vertical synchronization signal included in the variable refresh rate information being in an unstable state.

The controller may be configured to determine that the vertical synchronization signal is in an unstable state based on variation in a timing at which the vertical synchronization signal transitions to a high level.

The controller may be configured to match an output clock count of the second standard image with an output clock count of the first standard image.

The controller may be configured to match a horizontal synchronization signal of the second standard image with a horizontal synchronization signal of the first standard image.

The controller may be configured to match a vertical synchronization signal of the second standard image with a vertical synchronization signal of the first standard image.

The controller may be configured to match a synchronization pulse duration of a horizontal synchronization signal of the second standard image with a synchronization pulse duration of a horizontal synchronization signal of the first standard image.

The controller may be configured to match a back porch of the second standard image with a back porch of the first standard image.

The first standard port and the first standard image may include a DisplayPort (DP) format, and the second standard port and the second standard image may include a High Definition Multimedia Interface (HDMI) format.

According to an embodiment, a method for controlling a display apparatus may be provided. The method of controlling a display apparatus may include a second standard port connected to a first standard port of an external device and communication circuitry configured to receive a first standard image and variable refresh rate information through the second standard port. The method may further include: converting the first standard image to a second standard image based on the variable refresh rate information; and displaying the converted second standard image.

The converting of the first standard image to the second standard image may include converting the first standard image to the second standard image based on a vertical synchronization signal included in the variable refresh rate information being in an unstable state.

The method may further include determining that the vertical synchronization signal is in an unstable state based on variation in a timing at which the vertical synchronization signal transitions to a high level.

The converting of the first standard image to the second standard image may include matching an output clock count of the second standard image with an output clock count of the first standard image to convert the first standard image to the second standard image.

The converting of the first standard image to the second standard image may include matching a horizontal synchronization signal of the second standard image with a horizontal synchronization signal of the first standard image to convert the first standard image to the second standard image.

The converting of the first standard image to the second standard image may include matching a vertical synchronization signal of the second standard image with a vertical synchronization signal of the first standard image to convert the first standard image to the second standard image.

The converting of the first standard image to the second standard image may include matching a synchronization pulse duration of a horizontal synchronization signal of the second standard image with a synchronization pulse duration of a horizontal synchronization signal of the first standard image to convert the first standard image to the second standard image.

The converting of the first standard image to the second standard image may include matching a back porch of the second standard image with a back porch of the first standard image to convert the first standard image to the second standard image.

According to an aspect of the disclosure, one or more embodiments of the disclosure can detect a VRR activation signal received from a source device equipped with a DP interface to provide a VRR function on a sink device equipped with an HDMI interfaces, and increase compatibility between a source device and a display apparatus, thereby improving consumer satisfaction.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 shows an external view of a display apparatus and an electronic device according to an embodiment;

FIG. 2 shows a control block diagram of a display apparatus according to an embodiment;

FIG. 3 shows a control block diagram of a display apparatus and an electronic device according to an embodiment;

FIG. 4 shows a control block diagram of a display apparatus providing a VRR function according to an embodiment;

FIG. 5 shows a timing diagram of transmission of a single frame by a display apparatus according to an embodiment;

FIG. 6 shows a schematic diagram of transmission of a single frame by a display apparatus according to an embodiment;

FIG. 7 is a diagram illustrating reception of image in accordance with the DP standard at a fixed refresh rate by a display apparatus according to an embodiment;

FIG. 8 is a diagram illustrating reception of image in accordance with the DP standard at a variable refresh rate by a display apparatus according to an embodiment;

FIG. 9 is a diagram illustrating reception of image in accordance with the HDMI standard at a fixed refresh rate by a display apparatus according to an embodiment;

FIG. 10 is a diagram illustrating reception of image in accordance with the HDMI standard at a variable refresh rate by a display apparatus according to an embodiment; and

FIG. 11 is a chart illustrating a control flow of a display apparatus according to an embodiment.

### DETAILED DESCRIPTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the terms “1st” or “first” and “2nd” or “second” may use corresponding components regardless of importance or order and are used to distinguish one component from another without limiting the components.

When one (e.g., a first) element is referred to as being “coupled” or “connected” to another (e.g., a second) element with or without the term “functionally” or “communicatively,” it may mean that the one element is connected to the other element directly, wirelessly, or via a third element.

It will be understood that the terms “include”, “comprise” and/or “have” when used in this specification, specify the presence of stated features, integers, steps, operations, elements, and/or components, but do not preclude the presence or addition of one or more other features, integers, steps, operations, elements, components, and/or groups thereof.

It is to be understood that if a certain component is referred to as being “coupled with,” “coupled to,” “supported on” or “in contact with” another component, it means that the component may be coupled with the other component directly or indirectly via a third component.

Throughout the specification, when a member is referred to as being “on” another member, the member is in contact with another member or yet another member is interposed between the two members.

The term “and/or” includes combinations of one or all of a plurality of associated listed items.

The display apparatus 100 may be at least one of various types of home appliances. For example, the display apparatus 100 may, as shown in the accompanying drawings, include a refrigerator, a dishwasher, an electric range, an electric oven, an air conditioner, a clothing care apparatus, a washing machine, a dryer, and a microwave oven. For example, the display apparatus 100 may include various types of appliances not shown in the drawings, such as a cleaning robot, a vacuum cleaner, a television, and the like. Furthermore, the aforementioned home appliances are nonlimiting examples.

The display apparatus 100 may communicate with a server. The server may include: a communication module capable of communicating with another server, the display apparatus 100, or a user device; at least one processor capable of processing data received from another server, the display apparatus 100, or a user device; and at least one memory capable of storing a program for processing data or processed data. The server may be implemented as a variety of computing devices, such as a workstation, a cloud, a data drive, a data station, and the like. The server may be implemented as one or more server physically or logically separated based on a function, detailed configuration of function, or data, and may transmit and receive data through communication between servers and process the transmitted and received data.

The server may perform functions such as managing a user account, registering the display apparatus 100 in association with the user account, managing or controlling the display apparatus 100, and the like. For example, a user may access the server via the user device and may generate a user account. The user account may be identified by an identifier (ID) and a password set by the user. The server may register the display apparatus 100 to the user account according to a predetermined procedure. For example, the server may link identification information (such as a serial number or MAC address) of the display apparatus 100 to the user account to register, manage, and control the display apparatus 100. The user device may include: a communication module capable of communicating with the server; a user interface receiving a user input or outputting information to a user; at least one processor controlling an operation of the user device; and at least one memory storing a program for controlling the operation of the user device.

The user device may be carried by a user, or placed in a user's home or office, or the like. The user device may include a personal computer, a terminal, a portable telephone, a smartphone, a handheld device, a wearable device, and the like.

The memory of the user device may store a program for controlling a display apparatus 100, e.g., an application. The application may be sold, installed on the user device, or may be downloaded from an external server for installation.

By executing the application installed on the user device by a user, the user may access the server, generate a user account, and perform communication with the server based on the login user account to register the display apparatus 100.

For example, by operating the display apparatus 100 to enable other home appliances to access the server according to a procedure guided by the application installed on the user device, the server may register the display apparatus 100 with the user account by assigning the identification information (such as a serial number or MAC address) of other home appliances to the corresponding user account.

A user may control the display apparatus 100 using the application installed on the user device. For example, by logging into a user account with the application installed on the user device, the display apparatus 100 registered to the user account appears, and by inputting a control command for the display apparatus 100, the control command may be delivered to the display apparatus 100 via the server.

A network may include both a wired network and a wireless network. The wired network may include a cable network or a telephone network, and the wireless network may include any networks transmitting and receiving a signal via radio waves. The wired network and the wireless network may be connected to each other.

The network may include a Wide Area Network (WAN) such as the Internet, a Local Area Network (LAN) formed around an Access Point (AP), and a short range wireless network not using an AP. The short range wireless network may include Bluetooth (IEEE 802.15.1), Zigbee (IEEE 802.15.4), Wi-Fi Direct, Near Field Communication (NFC), and Z-Wave.

The AP may connect the display apparatus 100 or the user device to a WAN connected to the server. The display apparatus 100 or the user device may be connected to the server via a WAN.

The AP may communicate with the display apparatus 100 or the user device using wireless communication such as Wi-Fi (IEEE 802.11), Bluetooth (IEEE 802.15.1), Zigbee (IEEE 802.15.4, and the like, and access a WAN using wired communication.

According to various embodiments, the display apparatus 100 may be directly connected to the user device or server without going through an AP.

The display apparatus 100 may be connected to the user device or the server via a long range wireless network or a short range wireless network.

For example, the display apparatus 100 may be connected to the user device via a short range wireless network (e.g., Wi-Fi Direct).

In another example, the display apparatus 100 may be connected to the user device or the server via a WAN using a long range wireless network (e.g., a cellular communication module).

In another example, the display apparatus 100 may access a WAN using wired communication, and may be connected to other home appliances or the server via a WAN.

Upon accessing a WAN using wired communication, the display apparatus 100 may also act as an access point. Accordingly, the display apparatus 100 may connect other home appliances to a WAN to which the server is connected. Further, other home appliances may connect the display apparatus 100 to the WAN to which the server is connected.

The display apparatus 100 may transmit information about an operation or state to other home appliances, the user device, or the server via the network. For example, the display apparatus 100 may transmit information about an operation or state to other home appliances, the user device, or the server upon receiving a request from the server, in response to an event in the display apparatus 100, or periodically, or in real time. In response to receiving the information about the operation or state from the display apparatus 100, the server may update the stored information about the operation or state of the display apparatus 100 and transmit the updated information about the operation and state of the display apparatus 100 to the user device via the network. For example, updating the information may include various operations in which existing information is changed, such as adding new information to the existing information, replacing the existing information with new information, and the like.

The display apparatus 100 may obtain various information from other home appliances, the user device, or the server, and may provide the obtained information to a user. For example, the display apparatus 100 may obtain information related to a function of the display apparatus 100 (e.g., recipes, washing instructions, and the like) from the server and various environment information (e.g., weather, temperature, humidity, and the like), and may output the obtained information via a user interface.

The display apparatus 100 may operate according to a control command received from other home appliances, the user device, or the server. For example, the display apparatus 100 may operate in accordance with a control command received from the server, based on a prior authorization obtained from a user to operate in accordance with the control command of the server even without a user input. For example, the control command received from the server may include a control command input by the user via the user device or a control command based on preset conditions, without being limited thereto.

The user device may transmit information about a user to the display apparatus 100 or the server through the communication module. For example, the user device may transmit information about a user's location, a user's health status, a user's preference, a user's schedule, and the like to the server. The user device may transmit information about the user to the server based on the user's prior authorization.

The display apparatus 100, the user device, or the server may use techniques such as artificial intelligence to determine a control command. For example, the server may receive information about an operation or a state of the display apparatus 100 or information about a user of the user device, process the received information using techniques such as artificial intelligence, and transmit a processing result or a control command to the display apparatus 100 or the user device based on the processing result.

Hereinafter, the operating principles and embodiments of the present disclosure will be described with reference to the accompanying drawings.

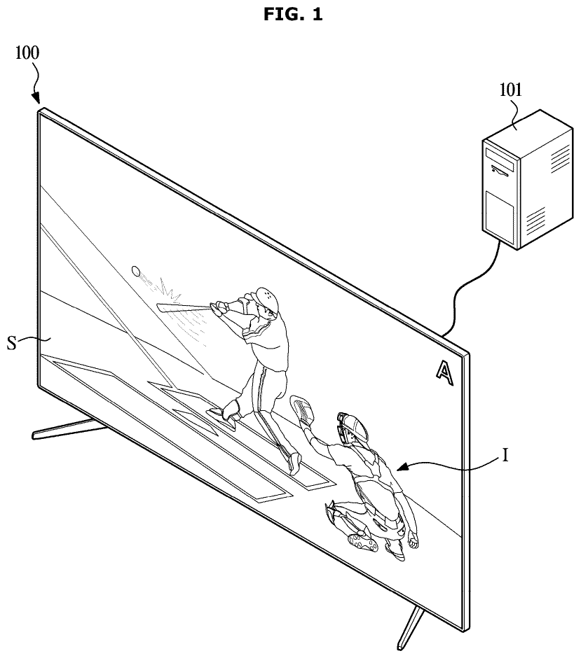

FIG. 1 shows an external view of a display apparatus and an electronic device according to an embodiment.

Referring to FIG. 1, a display apparatus 100 may be connected to an electronic device 101 via a wired or wireless connection.

The display apparatus 100 may be a device that processes an image signal received from an external source and visually displays the processed image. For example, the display apparatus 100 may be a television, a monitor, a portable multimedia device, and a portable communication device of various shapes.

The display apparatus 100 may be a large format display (LFD) installed outdoors, such as on a roof of a building or at a bus stop. The display apparatus 100 according to an embodiment may be installed in any other place as long as the display apparatus 100 may be accessed by a large number of people, even indoors, such as subway stations, shopping malls, movie theaters, companies, and stores.

The display apparatus 100 may receive content data including image signal and audio signal from various content sources and output video and audio corresponding to the image signal and the audio signal. For example, the display apparatus 100 may receive television broadcast content through a broadcast reception antenna or cable, receive content from a content playback device, or receive content from a content providing server of a content provider.

The display apparatus 100 may include a main body that accommodates a plurality of components for displaying image and a screen S provided on one side of the main body to display an image I.

The main body may form an appearance of the display apparatus 100, and include components—provided inside the main body—that allow the display apparatus 100 to display image I. Although the main body shown in FIG. 1 is in the form of a flat plate, the shape of the main body is not limited thereto. For example, the main body may have a curved shape in which both lateral ends protrude forward and the central portion is recessed. The screen S may be formed on a front side of the main body, and display the image I as visual information.

The screen S includes a plurality of pixels P, and the image I displayed on the screen S may be formed by a combination of lights emitted from the plurality of pixels. For example, light emitted by the pixels may combine in a mosaic-like manner to form a single image I on the screen S.

Each of the plurality of pixels may emit different brightness and different color of light.

To emit light of different brightness levels, each pixel may include a component, such as a liquid crystal molecule that selectively transmits or blocks light emitted from a backlight unit.

To emit light in various colors, each of the plurality of pixels may include sub-pixels Psub1, Psub2, and Psub3. For example, the sub-pixels may include a red sub-pixel that emits red light, a green sub-pixel that emits green light, and a blue sub-pixel that emits blue light (RGB pixels).

In another example, the sub-pixels may include a red sub-pixel, a green sub-pixel, a blue sub-pixel, and a white sub-pixel that emits white light (RGBW pixels). In yet another example, the sub-pixels may include a red sub-pixel, a green sub-pixel, a blue sub-pixel, and a yellow sub-pixel that emits yellow light (RGBY pixels).

The electronic device 101 may be operated by producers, sellers, or service agents of the display apparatus 100.

The electronic device 101 may include a database that stores data related to image retention occurring in the display apparatus 100.

The electronic device 101 may receive operation information and environmental information from the display apparatus 100 via a wired connection, and may determine whether image retention has occurred in the display apparatus 100 based on the operation information and environmental information of the display apparatus 100. The electronic device 101 may produce various embodiments of compensation frames, which will be described below, and may provide them to the display apparatus 100.

The electronic device 101 may operate as a type of cloud server. For example, the electronic device 101 may receive a request from the display apparatus 100 on the web and, in response to the request from the display apparatus 100, provide parameters for correcting image quality changes due to long-term use of the display apparatus 100 to the display apparatus 100.

However, the electronic device 101 is not limited to a cloud server. For example, the communication network NT may be omitted, and the display apparatus 100 and the electronic device 101 may be directly connected. When the display apparatus 100 and the electronic device 101 are directly connected, the electronic device 101 may be a peripheral device of the display apparatus 100, such as a desktop computer or laptop computer.

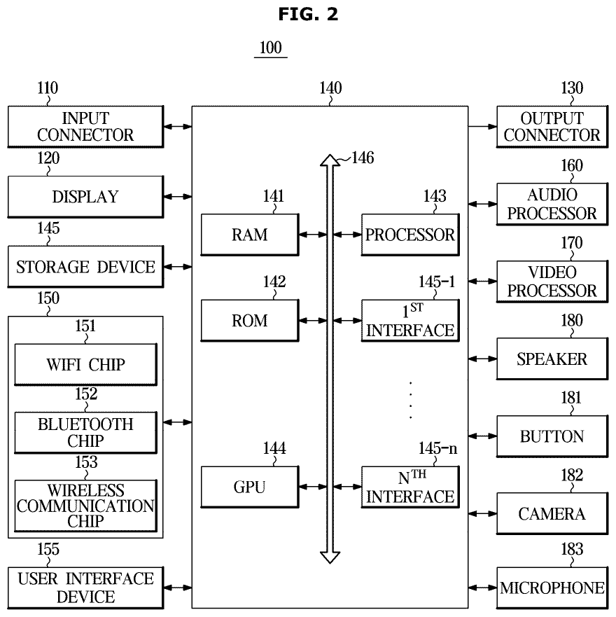

FIG. 2 shows a control block diagram of a display apparatus according to an embodiment.

Referring to FIG. 2, a display apparatus 100 may include an input connector 110, a display 120, an output connector 130, a controller 140, a storage device 145, communication circuitry 150, a user interface device 155, an audio processor 160, a video processor 170, a speaker 180, a button 181, a camera 182, and a microphone 183.

The controller 140 may control the operation of the display apparatus 100 using various programs stored in the storage device 145.

Specifically, the controller 140 may include a random access memory (RAM) 141, a read-only memory (ROM) 142, at least one processor 143, a graphics processing unit (GPU) 144, first to nth interfaces 145-1 to 145-n, and a bus 146.

The RAM 141, the ROM 142, the processor 143, the graphics processing unit 144, the first to nth interfaces 145-1 to 145-n may be connected to each other through the bus 146.

The first to nth interfaces 145-1 to 145-n may be connected to the various components described above. One of the interfaces may be a network interface connected to an external device via a network.

The processor 143 may access the storage device 145 and perform booting using an operating system (O/S) stored in the storage device 145. The processor 143 may subsequently perform various operations using various programs stored in the storage device 145.

The ROM 142 may store instruction sets for system booting. When a turn-on command is input and power is supplied, the processor 143 copies the O/S stored in the storage device 145 to the RAM 141 according to instructions stored in the ROM 142, executes the O/S to boot the system. When booting is complete, the processor 143 may copy various application programs stored in the storage device 145 to the RAM 141 and may execute the application programs copied to the RAM 141 to perform various operations.

The graphics processing unit 144 may generate screens including various objects such as icons, images, and text using a calculation device (not shown) and a rendering device (not shown). The calculation device (not shown) may calculate attribute values such as coordinate values at which each object is to be displayed, shapes, sizes, and colors according to the screen layout based on received control commands. The rendering device (not shown) may generate screens of various layouts including objects based on the attribute values calculated by the calculation device (not shown). Screens generated by the rendering device (not shown) may be displayed within a display area of the display.

Meanwhile, the operations of the processor 143 described above may be performed by programs stored in the storage device 145.

The storage device 145 may store various types of data such as an O/S software module for driving the display apparatus 100 and an image processing module.

In this case, the processor 143 may process input image based on information stored in the storage device 145 and display the processed image.

The input connector 110 may include an input port for the display apparatus 100 to receive image and may include interface standards such as DisplayPort (DP) and High Definition Multimedia Interface (HDMI).

The input connector 110 may include an input port for the display apparatus 100 to receive image and may include interface standards such as DisplayPort (DP) and High Definition Multimedia Interface (HDMI).

The user interface device 155 may receive various user interactions. For example, the user interface device 155 may be implemented in various forms depending on the embodiment of the display apparatus 100. When the display apparatus 100 is implemented as a general digital TV, the user interface device 155 may be implemented as a remote control receiver that receives remote control signals from a remote control device, a camera that detects user motion, a microphone that receives user voice, and the like. In addition, when the display apparatus 100 is implemented as a digital TV that provides a touch function, the user interface device 155 may be implemented as a touch screen that forms a layered structure with a touchpad. In this case, the user interface device 155 may be used as the display described above.

The audio processor 160 may be a component that performs processing on audio data. The audio processor 160 may perform various processing such as decoding, amplification, and noise filtering on audio data.

The video processor 170 may be a component that performs processing on video data. The video processor 170 may perform various image processing such as decoding, scaling, noise filtering, frame rate conversion, and resolution conversion on video data.

The speaker 180 may be a component that outputs audio data processed by the audio processor, various notification sounds, and voice messages.

The button 181 may be various types of buttons such as a mechanical button, a touch pad, a wheel, and the like formed in arbitrary areas such as the front, side, or rear surface of the exterior of the main body of the display apparatus 100.

The camera 182 may be configured to capture still images or images according to user control. The camera 182 may be implemented as a plurality of cameras such as a front camera and a rear camera. The microphone 183 is configured to receive user voice or other sounds and convert the received user voice or other sounds to audio data.

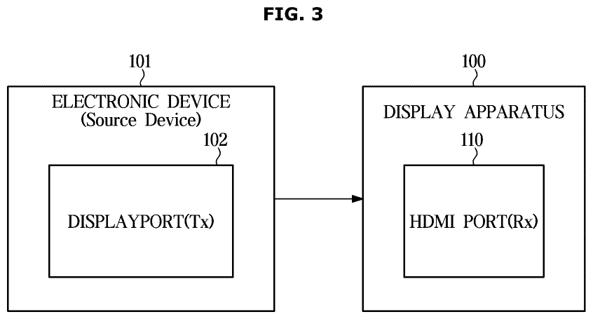

FIG. 3 shows a control block diagram of a display apparatus and an electronic device according to an embodiment.

Referring to FIG. 3, a link of a DisplayPort (Tx) 102 interface may include a Main Link, an auxiliary channel (AUX CH), and a hot plug detect (HPD) line. The main link is a unidirectional channel that has high bandwidth and short call time, and may be used for transmitting isochronous streams such as video data and audio. The main link may be referred to as a “lane” and may be composed of two or four data pairs.

The auxiliary channel (AUX CH) may be a bidirectional channel that may be used for link management and device control. The auxiliary channel (AUX CH) may be used to transmit data signals for establishing or configuring the main link between the electronic device 101, which is a source device, and the display apparatus 100, which is a sink device, or to transmit data for controlling the electronic device 101 or the display apparatus 100.

The display apparatus 100 may include a link policy maker, a stream policy maker, an Extended Display Identification Data (EDID), and a DisplayPort Configuration Data (DPCD).

The EDID may include information such as a manufacturer, a manufacturing date, an identification number, and a supported resolution of the display apparatus 100. The DPCD may include information such as a transmission rate, the number of transmission lanes, voltage parameters of transmission signals, results of link training, and status information of the main link. The voltage parameters of transmission signals may include voltage-swing and pre-emphasis.

Through the auxiliary channel, auxiliary information such as EDID and DPCD stored in the memory of the display apparatus 100 may be transmitted. The auxiliary channel (AUX CH) may be used for link training for link matching in a connection stage between the electronic device 101 and the display apparatus 100. The electronic device 101, which is a source device, may use the auxiliary channel to check the validity and status of the main link and implement modifications to the main link using the auxiliary channel. In other words, the auxiliary channel may be used to establish and maintain the main link connections.

The HPD line may be used for transmitting connection and disconnection signals by the sink device. The sink device may transmit an HPD signal to the source device. The HPD signal may be a signal requesting link training.

The display apparatus 100, which is a sink device, may receive image from the electronic device 101, which is a source device. The electronic device 101 may be equipped with a DisplayPort (Tx) 102, and the display apparatus 100 may be equipped with an HDMI port (Rx) 110.

Accordingly, the display apparatus 100 may receive image through the HDMI port (Rx) 110 and convert the image based on a vertical synchronization signal included in variable refresh rate information received from the DisplayPort (Tx) 102 being in an unstable state to provide variable refresh rate (VRR) function.

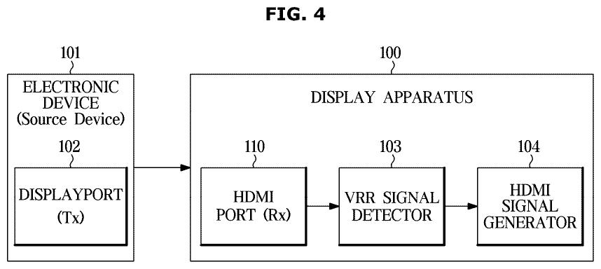

FIG. 4 shows a control block diagram of a display apparatus providing a VRR function according to an embodiment.

Referring to FIG. 4, the display apparatus 100, which is a sink device, may receive image from the electronic device 101, which is a source device. The electronic device 101 may be equipped with a DisplayPort (Tx) 102, and the display apparatus 100 may be equipped with an HDMI port (Rx) 110 to receive image.

The display apparatus 100 includes a controller 140, and the controller 140 may include a VRR signal detector 103 and an HDMI signal generator 104. The VRR signal detector 103 may detect a VRR signal transmitted from the electronic device 101 to provide a variable refresh rate (a variable scanning rate) function and may generate a signal corresponding to the HDMI interface.

The variable refresh rate (or a variable scanning rate) function refers to a function for preventing screen tearing from occurring in the display apparatus 100 that has a fixed number of frames per second.

For example, in the case of 3D games in which the number of frames transmitted from a source device changes rapidly, performance requirements may change drastically depending on the scene occurring in the game. Accordingly, when the display apparatus 100 displays 3D games, it is common for a system that stably displayed more than 100 frames per second to have a sudden drop in frame rate to below 60 frames due to large explosions or the use of smoke grenades or conversely, an increase to above 130 frames. In such cases, while the display apparatus 100 is rendering the middle point of the screen, the source device may transmit the next screen, resulting in the screen appearing torn in the middle, which is a phenomenon known as screen tearing.

A vertical synchronization (V-sync) function to prevent the screen tearing is a method of ensuring a waiting time by allowing the source device to transmit the next frame in accordance with a timing at which the display presents a single frame. The vertical synchronization function may prevent screen tearing, but may lead to stuttering caused by waiting time.

In contrast, the variable refresh rate function may prevent both screen tearing and stuttering and may be configured to start displaying a screen in accordance with the timing at which the source device transmits a new screen, instead of following a fixed refresh rate of the display apparatus 100. With such a configuration, even when the frame rate varies at the source device, the display apparatus 100 may adjust the frame display timing to thereby display screens at optimal timing. Accordingly, the variable refresh rate function may prevent not only screen tearing but also stuttering caused by waiting time.

However, the conventional technologies only support the variable refresh rate function when the input connector 110 and the output connector 130 have the same standard, resulting in reduced compatibility. The display apparatus 100 according to an embodiment provides a display apparatus 100 that supports the variable refresh rate function even when the input connector 110 and the output connector 130 follow different standards.

Specifically, the VRR signal detector 103 of the display apparatus 100 according to an embodiment may detect an unstable state of a vertical synchronization signal (Vsync) when a fixed timing mode is switched to a variable refresh rate (VRR Timing) mode.

For example, the source device, when outputting image in a variable refresh rate mode, changes the frames per second of the image by varying the vertical synchronization signal, and thus the VRR signal detector 103 may detect whether the vertical synchronization signal varies. In this case, the VRR signal detector 103 may determine that the vertical synchronization signal is in an unstable state based on a variation in the timing, at which the vertical synchronization signal transitions to a high level.

The HDMI signal generator 104 may, based on the VRR signal detector 103 determining that the vertical synchronization signal is in an unstable state, convert the image to operate a variable refresh rate mode. For example, the HDMI signal generator 104 may regenerate an output signal from the DP port into a HDMI signal to operate in a variable refresh rate mode. The HDMI signal generator 104 may, in order to convert output image from the DP port, convert the clock count, horizontal synchronization signal, vertical synchronization signal, synchronization pulse duration, back porch, and the like of the output image from the DP port to correspond to a HDMI port input image.

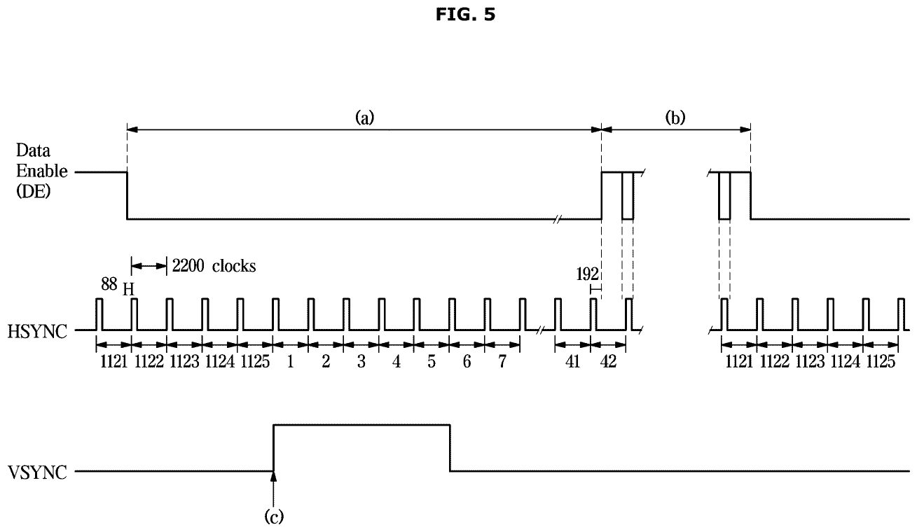

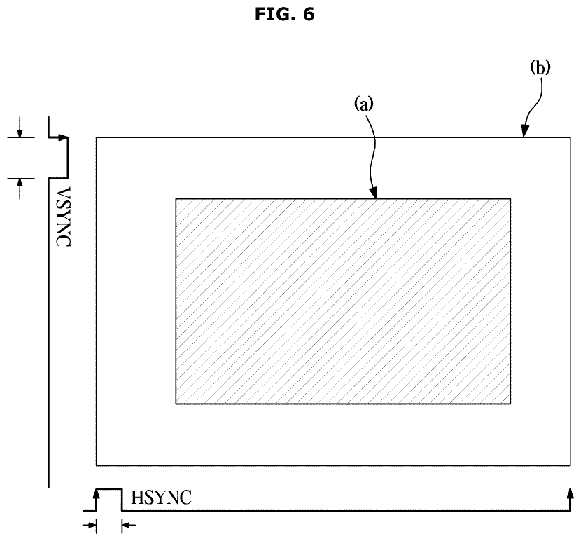

FIG. 5 shows a timing diagram of transmission of a single frame by a display apparatus according to an embodiment, and FIG. 6 shows a schematic diagram of transmission of a single frame by a display apparatus according to an embodiment.

Referring to FIG. 5, Data Enable (DE) refers to a signal indicating a valid data section, HSYNC refers to a signal indicating a start point of a single line of display in a frame, and VSYNC refers to a signal indicating a start point of a single plane of display in a frame.

A section in which the valid data signal is low is a V_Blank region (a), and the V_Blank region may be a preparation time for repositioning the scan line to display screen information on the display apparatus 100. A section in which the valid data signal is high is an Active Vertical Line region (b), and may be a section for displaying actual screen information on the display apparatus 100.

The display apparatus 100 may, in order to display a single screen, transition the VSYNC signal to High (c), and then sequentially transition the HSYNC signals to High to display a single frame.

Accordingly, an active area (a), which is an area in which a screen is actually transmitted, may be generated based on the VSYNC signal and HSYNC signals, and a blank area (b) excluding the active area (a) may be generated as shown in FIG. 6. The variable refresh rate function may vary the number of frames transmitted per second as described above and display the frames on the display apparatus 100, thereby preventing screen tearing and stuttering.

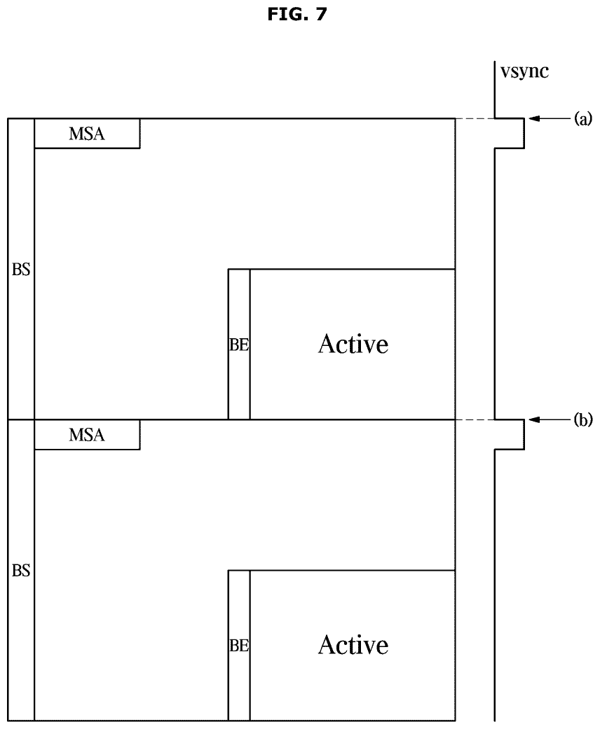

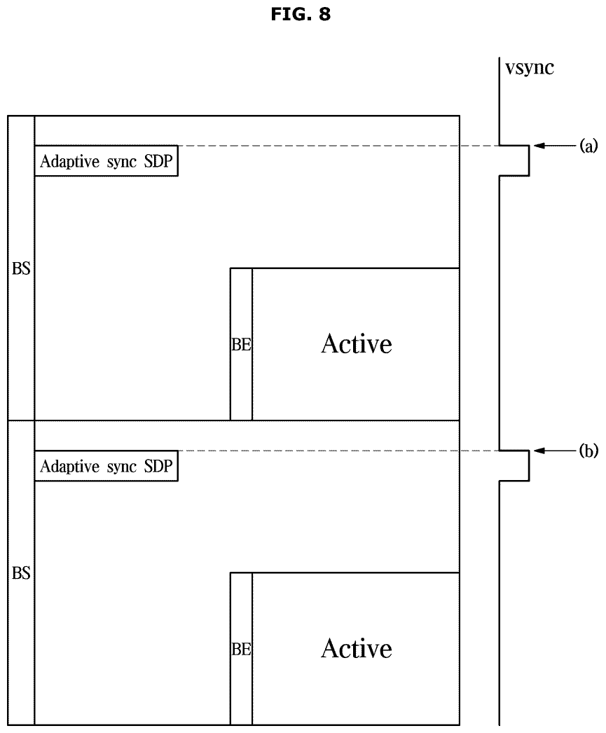

FIG. 7 is a diagram illustrating reception of image in accordance with the DP standard at a fixed refresh rate by a display apparatus according to an embodiment, and FIG. 8 is a diagram illustrating reception of image in accordance with the DP standard at a variable refresh rate by a display apparatus according to an embodiment.

Referring to FIGS. 7 and 8, when the electronic device 101, which is a source device, transmits image according to the DP standard, a single frame may be configured as shown by portion (a). Specifically, a single frame may be displayed based on the VSYNC signal, which is a signal indicating a starting point of a single plane of display in a frame.

In FIG. 7, since the display apparatus 100 receives image at a fixed refresh rate, the interval at which the VSYNC signal transitions to HIGH may be constant. For example, the interval from a time point at which the VSYNC signal transitions to HIGH in portion (a)7a to a time point at which the VSYNC signal transitions to HIGH in portion (b)7b may be consistently maintained across subsequent frames.

In contrast, in FIG. 8, since the display apparatus 100 receives an image at a variable refresh rate, the interval at which the VSYNC signal transitions to HIGH may vary. For example, the interval from a time point at which the VSYNC transitions to HIGH in portion (a) to a time point at which the VSYNC signal transitions to HIGH in portion (b) may vary across subsequent frames, resulting in the interval becoming narrower or wider.

As the interval between the time points at which the VSYNC signal transitions to HIGH varies, the display apparatus 100 may vary the number of frames displayed per second and provide a variable refresh rate function.

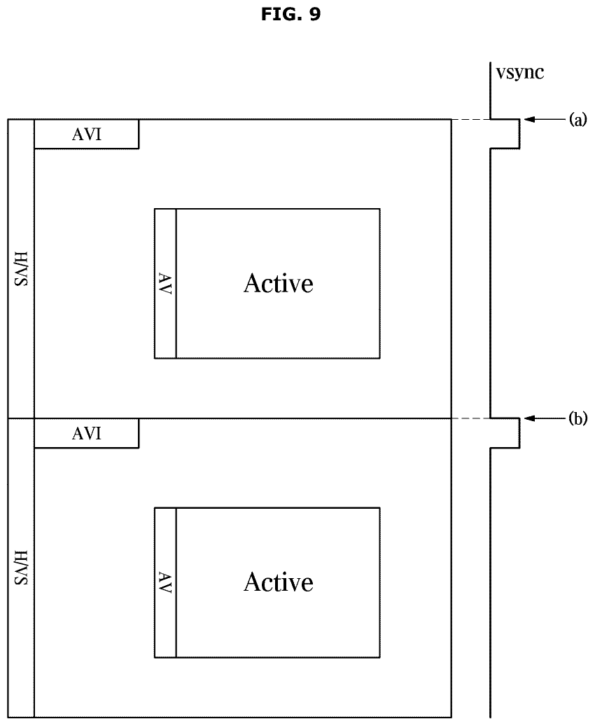

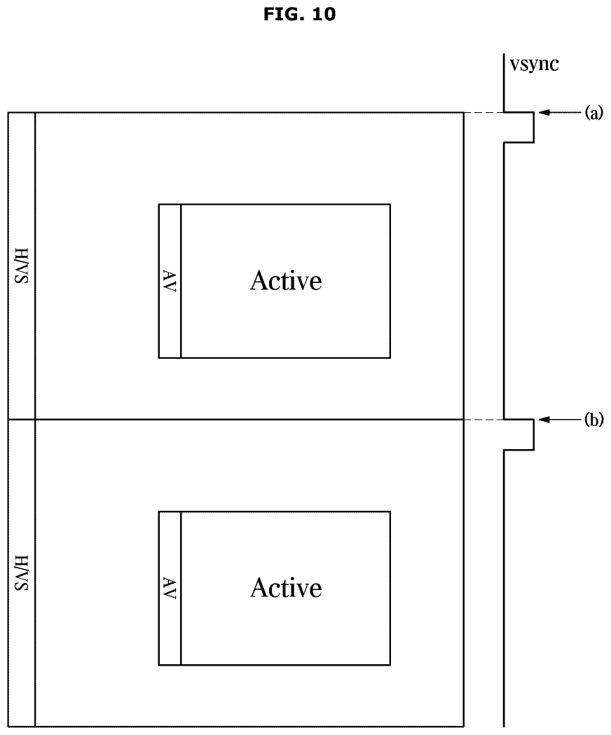

FIG. 9 is an exemplary diagram illustrating reception of image in accordance with the HDMI standard at a fixed refresh rate by a display apparatus according to an embodiment, and FIG. 10 is a diagram illustrating reception of image in accordance with the HDMI standard at a variable refresh rate by a display apparatus according to an embodiment.

In FIG. 9, since the display apparatus 100 receives image at a fixed refresh rate, the interval at which the VSYNC signal transitions to HIGH may be constant. For example, the interval from a time point at which the VSYNC signal transitions to HIGH in portion (a) to at time point at which the VSYNC signal transitions to HIGH in portion (b) may be consistently maintained across subsequent frames.

In contrast, in FIG. 10, since the display apparatus 100 receives image at a variable refresh rate, the interval at which the VSYNC signal transitions to HIGH may vary. For example, the interval from a time point at which the VSYNC transitions to HIGH in portion (a) to a time point at which the VSYNC signal transitions to HIGH in portion (b) may vary across subsequent frames, resulting in the interval becoming narrower or wider.

As the interval at which the VSYNC signal transitions to HIGH varies, the display apparatus 100 may vary the number of frames displayed per second and provide a variable refresh rate function.

However, the frame configuration in FIGS. 7 and 8 may differ from the frame configuration in FIGS. 9 and 10. Typically, the active area in FIGS. 7 and 8 may be generated at a lower right side of the frame, whereas the active area in FIGS. 9 and 10 may be generated at the center of the frame.

Accordingly, the controller 140 may convert image according to the DP standard into image according to the HDMI standard to provide the variable refresh rate function based on the variable refresh rate information included in the DP input.

Specifically, the controller 140 may match an output clock count of the image according to the HDMI standard, which will be output from the display apparatus 100, with an output clock count of the input DP standard image (HDMI-Tx Output Clock≈DP-Rx Clock).

In addition, the controller 140 may match a horizontal synchronization signal of the image according to the HDMI standard, which will be output from the display apparatus 100, with a horizontal synchronization signal of the input DP standard image (HDMI H-Total=DP H-Total).

In addition, the controller 140 may match a bandwidth of the horizontal synchronization signal of the image according to the HDMI standard, which will be output from the display apparatus 100, with a bandwidth of the horizontal synchronization signal of the input DP standard image (HDMI H-Sync Width=DP H-Sync Width).

In addition, the controller 140 may match a back porch of the horizontal synchronization signal of the image according to the HDMI standard, which will be output from the display apparatus 100, with a back porch of the horizontal synchronization signal of the input DP standard image (HDMI H-Sync Back Porch=DP H-Sync Back Porch).

In addition, the controller 140 may match a vertical synchronization signal of the image according to the HDMI standard, which will to be output from the display apparatus 100, with a vertical synchronization signal of the input DP standard image (HDMI V-Total=DP V-Total±1).

In addition, the controller 140 may match a bandwidth of the vertical synchronization signal of the image according to the HDMI standard, which will be output from the display apparatus 100, with a bandwidth of the vertical synchronization signal of the input DP standard image (HDMI V-Sync Width≈DP V-Sync Width).

In addition, the controller 140 may match a back porch of the vertical synchronization signal of the image according to the HDMI standard, which will be output from the display apparatus 100, with a back porch of the vertical synchronization signal of the input DP standard image (HDMI V-Sync Back Porch≈DP V-Sync Back Porch).

Accordingly, the controller 140 may allow even the display apparatus 100, which provide a variable refresh rate function based on the HDMI standard, to provide the variable refresh rate function by converting image according to the DP input.

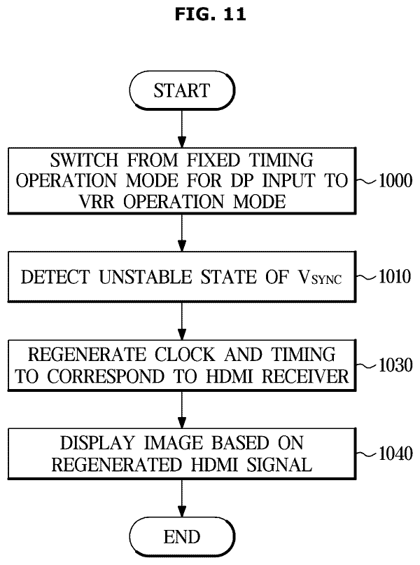

FIG. 11 is a chart illustrating a control flow of a display apparatus according to an embodiment.

Referring to FIG. 11, the electronic device 101, which is a source device, may switch from a fixed timing operation mode for a DP input to a variable reference rate (VRR) operation mode (1000). Thereafter, the controller 140 may detect that the vertical synchronization signal (VSYNC) is in an unstable state (1010). For example, when the vertical synchronization signal (VSYNC) is referred to as being in an unstable state, it means that the timing at which the vertical synchronization signal transitions to a high level varies as described above.

Thereafter, the controller 140 may regenerate an image signal according to the DP standard into a signal having clock and timing that are converted to correspond to the HDMI standard (1030).

The controller 140 may display an image based on the regenerated HDMI signal (1040). Accordingly, in an embodiment, the display apparatus 100 may support a DP interface and a DP VRR function in a smart gaming monitor product, thereby increasing compatibility between a source device and the display apparatus 100 and improving consumer satisfaction.

A display apparatus 100 according to an embodiment includes: a second standard port connected to a first standard port of an external device; communication circuitry 150 configured to receive a first standard image and variable refresh rate information through the second standard port; a controller 140 configured to convert the first standard image to a second standard image based on the variable refresh rate information; and a display 120 on which the converted second standard image is displayed.

The controller 140 may convert the first standard image to the second standard image based on a vertical synchronization signal included in the variable refresh rate information being in an unstable state.

The controller 140 may be configured to determine that the vertical synchronization signal is in an unstable state based on variation in a timing at which the vertical synchronization signal transitions to a high level.

The controller 140 may be configured to match an output clock count of the second standard image with an output clock count of the first standard image.

The controller 140 may be configured to match a horizontal synchronization signal of the second standard image with a horizontal synchronization signal of the first standard image.

The controller 140 may be configured to match a vertical synchronization signal of the second standard image with a vertical synchronization signal of the first standard image.

The controller 140 may be configured to match a synchronization pulse duration of a horizontal synchronization signal of the second standard image with a synchronization pulse duration of a horizontal synchronization signal of the first standard image.

The controller 140 may be configured to match a back porch of the second standard image with a back porch of the first standard image.

The first standard port and the first standard image may include a DisplayPort (DP) format, and the second standard port and the second standard image may include a High Definition Multimedia Interface (HDMI) format.

A method of controlling a display apparatus 100 according to an embodiment includes a second standard port connected to a first standard port of an external device and communication circuitry 150 configured to receive a first standard image and variable refresh rate information through the second standard port, and includes: converting the first standard image to a second standard image based on the variable refresh rate information; and displaying the converted second standard image.

The converting of the first standard image to the second standard image may include converting the first standard image to the second standard image based on a vertical synchronization signal included in the variable refresh rate information being in an unstable state.

The method may further include: determining that the vertical synchronization signal is in an unstable state based on variation in a timing at which the vertical synchronization signal transitions to a high level.

The converting of the first standard image to the second standard image may include matching an output clock count of the second standard image with an output clock count of the first standard image to convert the first standard image to the second standard image.

The converting of the first standard image to the second standard image may include matching a horizontal synchronization signal of the second standard image with a horizontal synchronization signal of the first standard image to convert the first standard image to the second standard image.

The converting of the first standard image to the second standard image may include matching a vertical synchronization signal of the second standard image with a vertical synchronization signal of the first standard image to convert the first standard image to the second standard image.

The converting of the first standard image to the second standard image may include matching a synchronization pulse duration of a horizontal synchronization signal of the second standard image with a synchronization pulse duration of a horizontal synchronization signal of the first standard image to convert the first standard image to the second standard image.

The converting of the first standard image to the second standard image may include matching a back porch of the second standard image with a back porch of the first standard image to convert the first standard image to the second standard image.

The first standard port and the first standard image may include a DisplayPort (DP) format, and the second standard port and the second standard image may include a High Definition Multimedia Interface (HDMI) format.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which may be decoded by a computer are stored, for example, a Read Only Memory (ROM), a Random Access Memory (RAM), a magnetic tape, a magnetic disk, a flash memory, an optical data storage device, and the like.

The computer-readable recording medium may be provided in the form of a non-transitory storage medium. For example, when a storage medium is referred to as “non-transitory,” it can be understood that the storage medium is tangible and does not include a signal (electromagnetic waves), but rather that data is semi-permanently or temporarily stored in the storage medium. For example, a ‘non-temporary storage medium’ may include a buffer in which data is temporarily stored.

According to an embodiment, the methods according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed through an application store (e.g., Play Store™) online. In the case of online distribution, at least a portion of the computer program product may be stored at least semi-permanently or may be temporarily generated in a storage medium, such as a memory of a server of a manufacturer, a server of an application store, or a relay server.

Although embodiments of the present disclosure have been described with reference to the accompanying drawings, those skilled in the art will appreciate that these concepts of the disclosure may be embodied in different forms without departing from the scope and spirit of the disclosure, and should not be construed as limited to the embodiments set forth herein.

What is claimed is:

1. A display apparatus comprising:
a display;
a second standard port configured to be connected to a first standard port of an external device;
communication circuitry configured to receive a first standard image and variable refresh rate information through the second standard port;
a controller comprising at least one processor, wherein the controller is configured to:
convert the first standard image to a second standard image based on the variable refresh rate information, and
control the display to display the converted second standard image.

2. The display apparatus of claim 1, wherein the controller is further configured to convert the first standard image to the second standard image based on a vertical synchronization signal included in the variable refresh rate information being in an unstable state.

3. The display apparatus of claim 2, wherein the controller is further configured to determine that the vertical synchronization signal is in an unstable state based on variation in a timing at which the vertical synchronization signal transitions to a high level.

4. The display apparatus of claim 1, wherein the controller is further configured to match an output clock count of the second standard image with an output clock count of the first standard image.

5. The display apparatus of claim 1, wherein the controller is further configured to match a horizontal synchronization signal of the second standard image with a horizontal synchronization signal of the first standard image.

6. The display apparatus of claim 1, wherein the controller is further configured to match a vertical synchronization signal of the second standard image with a vertical synchronization signal of the first standard image.

7. The display apparatus of claim 1, wherein the controller is further configured to match a synchronization pulse duration of a horizontal synchronization signal of the second standard image with a synchronization pulse duration of a horizontal synchronization signal of the first standard image.

8. The display apparatus of claim 1, wherein the controller is further configured to match a back porch of the second standard image with a back porch of the first standard image.

9. The display apparatus of claim 1, wherein the first standard port and the first standard image have a DisplayPort (DP) format, and
the second standard port and the second standard image have a High Definition Multimedia Interface (HDMI) format.

10. A method of controlling a display apparatus including a second standard port connected to a first standard port of an external device and communication circuitry configured to receive a first standard image and variable refresh rate information through the second standard port, the method comprising:
converting the first standard image to a second standard image based on the variable refresh rate information; and
displaying the converted second standard image.

11. The method of claim 10, wherein the converting the first standard image to the second standard image comprises converting the first standard image to the second standard image based on a vertical synchronization signal included in the variable refresh rate information being in an unstable state.

12. The method of claim 11, wherein the vertical synchronization signal is determined to be in an unstable state based on variation in a timing at which the vertical synchronization signal transitions to a high level.

13. The method of claim 10, wherein the converting the first standard image to the second standard image comprises matching an output clock count of the second standard image with an output clock count of the first standard image to convert the first standard image to the second standard image.

14. The method of claim 10, wherein the converting the first standard image to the second standard image comprises matching a horizontal synchronization signal of the second standard image with a horizontal synchronization signal of the first standard image to convert the first standard image to the second standard image.

15. The method of claim 10, wherein the converting the first standard image to the second standard image comprises matching a vertical synchronization signal of the second standard image with a vertical synchronization signal of the first standard image to convert the first standard image to the second standard image.

16. The method of claim 10, wherein the converting the first standard image to the second standard image comprises matching a synchronization pulse duration of a horizontal synchronization signal of the second standard image with a synchronization pulse duration of a horizontal synchronization signal of the first standard image to convert the first standard image to the second standard image.

17. The method of claim 10, wherein the converting the first standard image to the second standard image comprises matching a back porch of the second standard image with a back porch of the first standard image to convert the first standard image to the second standard image.

18. A non-transitory computer readable medium storing one or more programs, the one or more programs comprising instructions to, when executed by an electronic device, cause the electronic device to:
convert a first standard image to a second standard image based on a variable refresh rate information; and
display the converted second standard image,
wherein the first standard image and the variable refresh rate information are received through a standard port.

19. The non-transitory computer readable storage medium of claim 18, wherein the first standard image is converted to the second standard image based on a vertical synchronization signal included in the variable refresh rate information being in an unstable state.

20. The non-transitory computer readable storage medium of claim 18, wherein the non-transitory computer readable storage medium further store instructions to match an output clock count of the second standard image with an output clock count of the first standard image to convert the first standard image to the second standard image.
